(19) United States
(12) Patent Application Publication
(10) Pub. No.: US 2026/0334358 A1
(43) Pub. Date: Oct. 29, 2026

(54) WORK MACHINE, METHOD OF CONTROLLING WORK MACHINE, AND STORAGE MEDIUM

(71) Applicant: KAWASAKI MOTORS, LTD., Akashi-shi (JP)

(72) Inventors: Kosuke OBAYASHI, Kobe-shi (JP); Ryuya TUZURA, Akashi-shi (JP)

(73) Assignee: KAWASAKI MOTORS, LTD., Akashi-shi (JP)

(21) Appl. No.: 19/649,262

(22) Filed: Apr. 16, 2026

(30) Foreign Application Priority Data
Apr. 25, 2025 (JP) 2025-073463

(51) Int. Cl. A01D 34/78; A01D 34/00; A01D 101/00

(52) U.S. Cl. CPC A01D 34/78; A01D 34/006; A01D 2101/00

(57) ABSTRACT

A work machine acquires an actual value of a parameter related to an output of a prime mover, acquires a requested value of the parameter based on a user operation amount with respect to an operating portion operated by a user, determines a gain in accordance with a predetermined control rule based on an absolute value of a deviation between the requested value and the actual value, and determines a torque command value with respect to the prime mover based on a value obtained by multiplying the deviation by the gain. The control rule is set such that the gain for a case where the absolute value of the deviation is a first value is smaller than the gain for a case where the absolute value of the deviation is a second value larger than the first value.

### CROSS-REFERENCE TO RELATED APPLICATION

This application claims priority to and the benefit of Japanese Patent Application No. 2025-73463 filed on Apr. 25, 2025, the entire disclosure of which is incorporated herein by reference.

### BACKGROUND OF THE INVENTION

### Field of the Invention

The present disclosure relates to a work machine, a method of controlling a work machine, and a storage medium.

### Description of the Related Art

U.S. Patent No. 2022/354049 discloses an electric lawn mower including a rear wheel driven by a wheel motor and a cutting blade driven by a cutting blade motor. A user performs lawn mowing work by causing the lawn mower to travel while rotating the cutting blade.

### SUMMARY OF THE INVENTION

Depending on conditions of grass and the like, the user may perform careful work while finely adjusting a traveling speed of the lawn mower. However, according to the current lawn mowers, it is not easy to finely adjust the traveling of the work machine during the lawn mowing work, and the feel is poor for the user.

An object of one aspect of the present disclosure is to allow a user to finely adjust the traveling of a work machine including work equipment with excellent feel during work performed by the work machine.

A work machine according to one aspect of the present disclosure includes: a body; work equipment that is mounted on the body and performs predetermined work with respect to surrounding environment of the work machine; a wheel supporting the body; a prime mover that drives the wheel; a sensor that detects a user operation amount with respect to an operating portion operated by a user; and processing circuitry configured to control the prime mover in response to a detection signal of the sensor. The processing circuitry is configured to acquire an actual value of a parameter related to an output of the prime mover, acquire a requested value of the parameter based on the user operation amount, determine a gain in accordance with a predetermined control rule based on an absolute value of a deviation between the requested value and the actual value, and determine a torque command value with respect to the prime mover based on a value obtained by multiplying the deviation by the gain. The control rule is set such that the gain for a case where the absolute value of the deviation is a first value is smaller than the gain for a case where the absolute value of the deviation is a second value larger than the first value.

A work machine control method according to one aspect of the present disclosure is a method of controlling a work machine, the work machine including: work equipment that performs predetermined work with respect to surrounding environment of the work machine; and a prime mover that drives a wheel, the method including: acquiring an actual value of a parameter related to an output of the prime mover; acquiring a requested value of the parameter based on a user operation amount; determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and determining a torque command value with respect to the prime mover based on a value obtained by multiplying the deviation by the gain.

A storage medium according to one aspect of the present disclosure is a non-transitory storage medium storing a control program for a work machine, the work machine including: work equipment that performs predetermined work with respect to surrounding environment of the work machine; and a prime mover that drives a wheel, the control program causing a processor to execute: acquiring an actual value of a parameter related to an output of the prime mover; acquiring a requested value of the parameter based on a user operation amount; determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and determining a torque command value with respect to the prime mover based on a value obtained by multiplying the deviation by the gain.

According to one aspect of the present disclosure, the user can finely adjust the traveling of the work machine with excellent feel during the work performed by the work equipment.

### BRIEF DESCRIPTION OF THE DRAWINGS

FIG. 1 is a block diagram of a lawn mower according to an embodiment.

FIG. 2 is a block diagram of a controller of FIG. 1.

FIG. 3 is a side view of an operating portion of the lawn mower of FIG. 1.

FIG. 4 is a block diagram of a control system of the lawn mower of FIG. 1.

FIG. 5A is a first gain map of the controller of FIG. 4.

FIG. 5B is a second gain map of the controller of FIG. 4.

FIG. 6 is a graph showing a relationship between an absolute value of a deviation between a requested value and an actual value, which are related to a rotational speed of a traveling motor, and a torque command value, under a condition where an absolute value of a user command value is constant.

FIG. 7 is a graph showing a relationship between the absolute value of the deviation between the requested value and the actual value, which are related to the rotational speed of the traveling motor, and the torque command value in the lawn mower according to Modified Example, under a condition where the absolute value of the user command value is constant.

### DETAILED DESCRIPTION

Hereinafter, an embodiment will be described with reference to the drawings. In the embodiment, a lawn mower 1 is described as one example of a work machine.

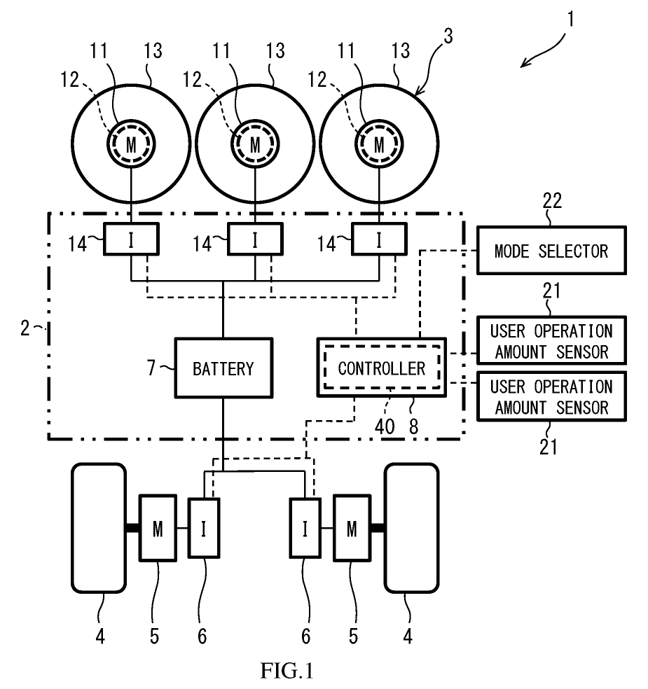

FIG. 1 is a block diagram of the lawn mower 1 according to the embodiment. As shown in FIG. 1, the lawn mower 1 includes a body 2, work equipment 3, wheels 4, a pair of left and right traveling motors 5, inverters 6, a battery 7, a controller 8, user operation amount sensors 21, a mode selector 22, and the like. The lawn mower 1 is, for example, a ride-on lawn mower.

The body 2 includes a frame. The work equipment 3 is mounted on the body 2. The work equipment 3 performs work of cutting grass growing on the ground around the lawn mower 1. Specifically, the work equipment 3 includes cutting blade motors 11, cutting blade driving shafts 12, cutting blades 13, and inverters 14. Each cutting blade motor 11 includes an electric motor that generates driving force for rotating the cutting blade 13. Each cutting blade driving shaft 12 is a main shaft to which the cutting blade 13 is attached. The cutting blade driving shaft 12 is rotated by the driving force of the cutting blade motor 11. Each inverter 14 converts direct current, supplied from the battery 7, into alternating current and supplies the alternating current to the cutting blade motor 11.

The wheels 4 support the body 2. FIG. 1 shows two wheels 4, but the number of wheels 4 is preferably four. In this case, two of the four wheels 4 may serve as driving wheels, and the remaining two wheels 4 may serve as driven wheels, or all four wheels 4 may serve as driving wheels.

Each traveling motor 5 is an example of a prime mover that drives the wheel 4. The traveling motor 5 is an electric motor. The electric motor tends to generate a more sudden torque change than an internal combustion engine. The inverters 6 are electrically connected to the pair of left and right traveling motors 5, respectively. The inverters 6 may be incorporated in the traveling motors 5. The battery 7 is electrically connected to the inverters 6. The controller 8 is electrically connected to the inverters 6. The controller 8 is also electrically connected to the inverters 14 of the work equipment 3.

The user operation amount sensor 21 for the right wheel 4 and the user operation amount sensor 21 for the left wheel 4 are electrically connected to the controller 8. Each user operation amount sensor 21 detects an operation amount of a below-described operating lever 31. The mode selector 22 is electrically connected to the controller 8. The mode selector 22 is operated by a user to switch an operating mode of the lawn mower 1. The mode selector 22 selects one mode from modes including a first mode and a second mode.

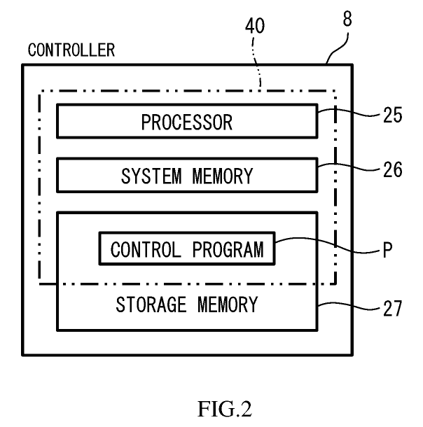

FIG. 2 is a block diagram of the controller 8 of FIG. 1. As shown in FIG. 2, the controller 8 includes processing circuitry 40. Specifically, the controller 8 includes a processor 25, a system memory 26, and a storage memory 27. The processor 25 may be a CPU (central processing unit). The system memory 26 includes a volatile memory. The storage memory 27 is an example of a computer-readable medium, and is a non-transitory, tangible medium. The storage memory 27 may include a non-volatile memory. The storage memory 27 may include a hard disk, a flash memory, or a combination thereof. The storage memory 27 stores a control program P. A configuration in which the processor 25 executes the control program P read into the system memory 26 is one example of the processing circuitry 40.

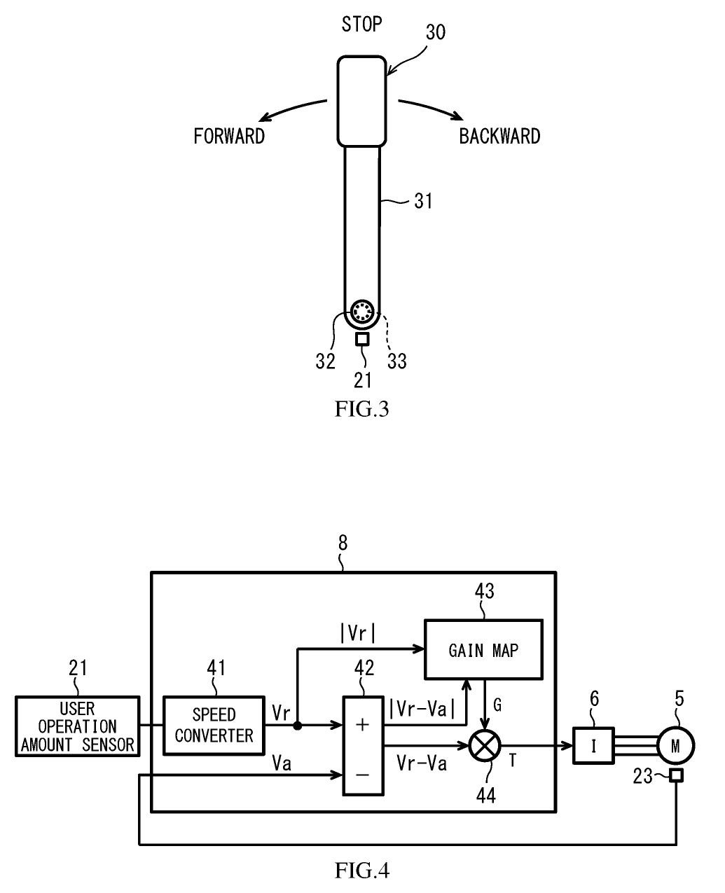

FIG. 3 is a side view of an operating portion 30 of the lawn mower 1 of FIG. 1. The lawn mower 1 includes the operating portion 30 for the right wheel 4 and the operating portion 30 for the left wheel 4. However, since these two operating portions 30 are the same in structure as each other, one of the operating portions 30 will be described below as a representative example. As shown in FIG. 3, the operating portion 30 includes the operating lever 31, a pivot shaft 32, and a spring 33. The operating portion 30 is operated by the user to command the operation of the traveling motor 5. The user operates the operating lever 31 with his/her hands to perform angular displacement of the operating lever 31 about the pivot shaft 32 as a spindle. The operating lever 31 is biased by the spring 33 so as to be positioned at a neutral position indicating a stop command.

The operating portion 30 includes the user operation amount sensor 21. The user operation amount sensor 21 detects the user operation amount with respect to the operating portion 30 operated by the user. In the present embodiment, the user operation amount sensor 21 detects a rotation angle of the operating lever 31. To be specific, the rotation angle of the operating lever 31 corresponds to the user operation amount with respect to the operating portion 30. The user operation amount sensor 21 includes, for example, a rotary encoder.

When the operating lever 31 is operated from the neutral position toward one side, the rotation angle of the operating lever 31 is regarded as positive. When the operating lever 31 is operated from the neutral position toward the other side, the rotation angle of the operating lever 31 is regarded as negative. When the operating lever 31 is at the neutral position, the rotation angle of the operating lever 31 is regarded as zero. The operation with respect to the operating lever 31 from the neutral position toward one side denotes a forward traveling command. The operation with respect to the operating lever 31 from the neutral position toward the other side denotes a backward traveling command.

When the lawn mower 1 is caused to travel straight forward, the user simultaneously operates both the operating lever 31 for the right wheel 4 and the operating lever 31 for the left wheel 4 forward. When the lawn mower 1 is caused to travel straight backward, the user simultaneously operates both the operating lever 31 for the right wheel 4 and the operating lever 31 for the left wheel 4 backward. When the lawn mower 1 is caused to turn right, the user operates the operating lever 31 for the left wheel 4 forward and operates the operating lever 31 for the right wheel 4 forward with an operation amount smaller than that of the operating lever 31 for the left wheel 4.

FIG. 4 is a block diagram of a control system of the lawn mower 1 of FIG. 1. As shown in FIG. 4, the controller 8 includes, as the processing circuitry 40, a speed converter 41, a subtracter 42, a gain map group 43, and a multiplier 44. To be specific, the speed converter 41, the subtracter 42, the gain map group 43, and the multiplier 44 are realized in such a manner that the processor 25 of FIG. 2 executes the control program P read into the system memory 26.

The speed converter 41 calculates a requested value Vr of the rotational speed of the traveling motor 5 based on the user operation amount. To be specific, the requested value Vr is an example of a user command value. The rotational speed of the traveling motor 5 is an example of a parameter related to an output of the traveling motor 5. Specifically, in accordance with a predetermined conversion rule, the speed converter 41 converts the rotation angle, detected by the user operation amount sensor 21, into the requested value Vr that denotes the rotational speed requested by the user for the traveling motor 5. The conversion rule is set such that the requested value Vr of the rotational speed of the traveling motor 5 increases as the rotation angle detected by the user operation amount sensor 21 increases.

The controller 8 receives an actual value Va of the rotational speed of the traveling motor 5 from a rotational speed sensor 23. The subtracter 42 calculates a deviation Vr-Va between the requested value Vr and the actual value Va by subtracting the actual value Va from the requested value Vr and also calculates an absolute value ⎪Vr-Va⎪ of this deviation.

The gain map group 43 includes gain maps including a below-described first gain map 43A and a below-described second gain map 43B. The gain map is an example of a control rule. The controller 8 refers to the gain map and determines a gain G based on an absolute value ⎪Vr⎪ of the requested value Vr and the absolute value ⎪Vr-Va⎪ of the deviation. The requested value Vr is an example of the user command value for determining the gain G. The user command value for determining the gain G may be the user operation amount itself detected by the user operation amount sensor 21. To be specific, the controller 8 may refer to the gain map and determine the gain G based on the absolute value of the user operation amount and the absolute value ⎪Vr-Va⎪ of the deviation. The user command value for determining the gain G may be the requested value Vr. In this case, the gain map for a case where the requested value Vr is positive and the gain map for a case where the requested value Vr is negative may be used.

The multiplier 44 calculates a torque command value T for commanding the inverter 6 by multiplying the deviation Vr-Va by the gain G obtained by referring to one gain map selected from the gain map group 43. The torque command value T corresponds to a current value supplied from the inverter 6 to the traveling motor 5.

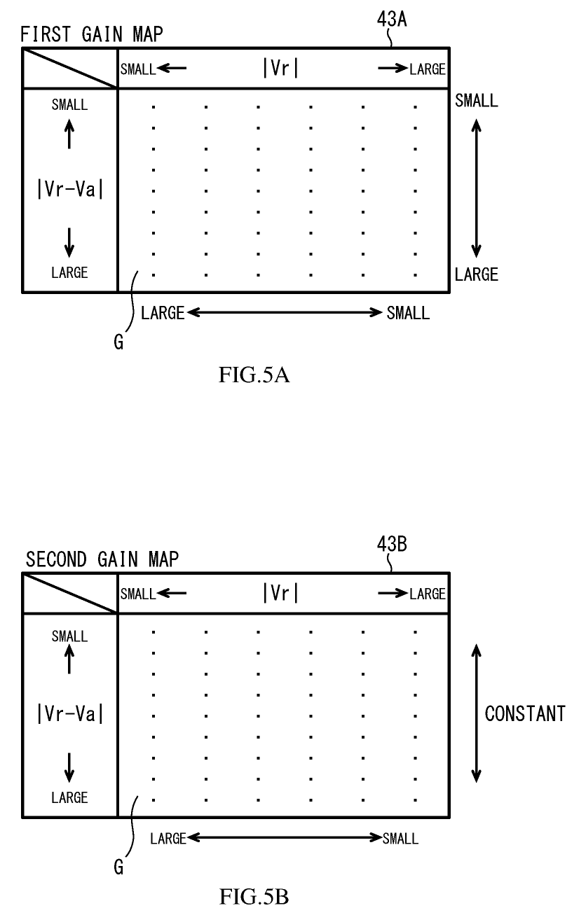

FIG. 5A shows the first gain map 43A of the controller 8 of FIG. 4. FIG. 5B shows the second gain map 43B of the controller 8 of FIG. 4. The first gain map 43A is an example of a first control rule used when the first mode is selected by the mode selector 22 shown in FIG. 1. The second gain map 43B is an example of a second control rule used when the second mode is selected by the mode selector 22 shown in FIG. 1. For simplicity, FIGS. 5A and 5B show a large number of dots in the gain maps 43A and 43B. However, numerical values indicating the gains G are actually shown.

The first mode is, for example, a mode in which the lawn mower 1 travels with the work equipment 3 operating. The second mode is, for example, a mode in which the lawn mower 1 travels with the work equipment 3 stopped. When the first mode is selected by the mode selector 22, the controller 8 operates the work equipment 3. When the second mode is selected by the mode selector 22, the controller 8 stops the work equipment 3.

As shown in FIG. 5A, the first gain map 43A is set such that under a condition where the absolute value ⎪Vr-Va⎪ of the deviation is constant, the gain G increases as the absolute value ⎪Vr⎪ of the requested value of the rotational speed of the traveling motor 5 decreases. Therefore, as the absolute value ⎪Vr⎪ of the requested value decreases, the torque command value T increases. Thus, the traveling torque of the lawn mower 1 when the target vehicle speed is low increases, and therefore, the traversability is improved.

The first gain map 43A is set such that under a condition where the absolute value ⎪Vr⎪ of the requested value of the rotational speed of the traveling motor 5 is constant, the gain G decreases as the absolute value ⎪Vr-Va⎪ of the deviation decreases. Therefore, as the absolute value ⎪Vr-Va⎪ of the deviation between the requested value Vr and the actual value Va decreases, the traveling responsiveness of the lawn mower 1 decreases. Thus, in a situation where the traveling of the lawn mower 1 needs to be finely adjusted during the work performed by the work equipment 3, a significant change in vehicle speed is suppressed.

As shown in FIG. 5B, as with the first gain map 43A, the second gain map 43B is set such that under a condition where the absolute value ⎪Vr-Va⎪ of the deviation is constant, the gain G increases as the absolute value ⎪Vr⎪ of the requested value of the rotational speed of the traveling motor 5 decreases. The second gain map 43B is set such that under a condition where the absolute value ⎪Vr⎪ of the requested value is constant, the gain G is constant regardless of the change in the absolute value ⎪Vr-Va⎪ of the deviation. Therefore, even when the absolute value ⎪Vr-Va⎪ of the deviation is small, the traveling responsiveness of the lawn mower 1 is high. Thus, the user can quickly move the lawn mower 1 with the work equipment 3 stopped.

The second gain map 43B may be set such that under a condition where the absolute value ⎪Vr-Va⎪ of the deviation is constant, the gain G is constant regardless of the change in the absolute value ⎪Vr⎪ of the requested value. The second gain map 43B may include: a region in which under a condition where the absolute value ⎪Vr⎪ of the requested value is a predetermined constant value, the gain G is set constant regardless of the change in the absolute value ⎪Vr-Va⎪ of the deviation; and a region in which under a condition where the absolute value ⎪Vr⎪ of the requested value is another constant value, the gain G is not constant with respect to the change in the absolute value ⎪Vr-Va⎪ of the deviation. For example, a torque limiter that sets the gain G to an upper limit value or less to prevent the torque command value T from becoming too large may be set in the second gain map 43B.

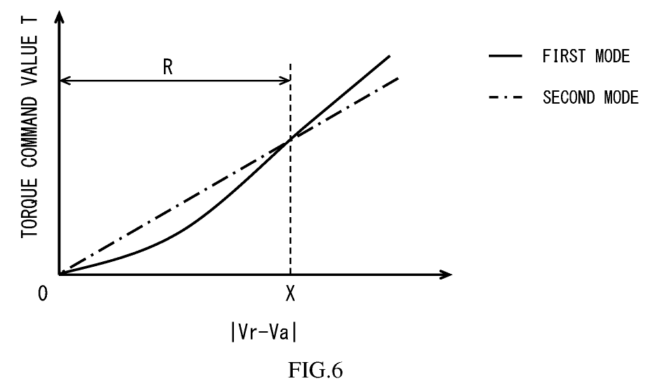

FIG. 6 is a graph showing a relationship between the absolute value ⎪Vr-Va⎪ of the deviation and the torque command value T, under a condition where the absolute value ⎪Vr⎪ of the requested value is constant. As shown in FIG. 6, in the second mode, the torque command value T increases proportionally as the absolute value ⎪Vr-Va⎪ of the deviation increases. In the first mode, the torque command value T increases along a quadratic curve as the absolute value ⎪Vr-Va⎪ of the deviation increases.

When the absolute value ⎪Vr-Va⎪ of the deviation is a value within a range R that is larger than zero and smaller than a predetermined threshold X, the torque command value T in the first mode is smaller than the torque command value T in the second mode. In other words, when the absolute value ⎪Vr-Va⎪ of the deviation is a value within the range R, the gain G determined in accordance with the first gain map 43A of FIG. 5A is smaller than the gain G determined in accordance with the second gain map 43B of FIG. 5B. Therefore, by selecting the first mode, the user can easily and finely adjust the traveling of the lawn mower 1.

When the absolute value ⎪Vr-Va⎪ of the deviation is a value larger than the threshold X, the torque command value T in the first mode is larger than the torque command value T in the second mode. In other words, when the absolute value ⎪Vr-Va⎪ of the deviation is a value larger than the threshold X, the gain G determined in accordance with the first gain map 43A of FIG. 5A is larger than the gain G determined in accordance with the second gain map 43B of FIG. 5B. When the absolute value ⎪Vr-Va⎪ of the deviation is a value larger than the threshold X, the gain G determined in accordance with the first gain map 43A of FIG. 5A may be equal to the gain G determined in accordance with the second gain map 43B of FIG. 5B.

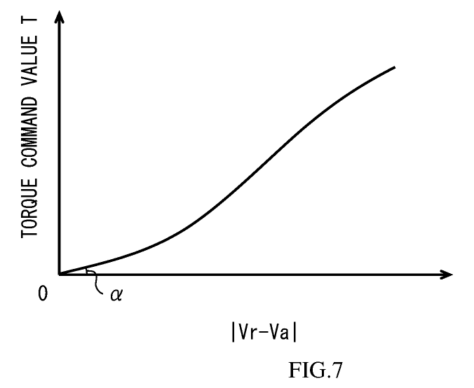

FIG. 7 is a graph showing a relationship between the absolute value ⎪Vr-Va⎪ of the deviation between the requested value Vr and the actual value Va and the torque command value T in the lawn mower according to Modified Example, under a condition where the absolute value ⎪Vr⎪ of the requested value is constant. The lawn mower according to Modified Example does not have a mode switching function and includes only a single gain map. As shown in FIG. 7, a change rate α of the torque command value T in accordance with the change in the absolute value ⎪Vr-Va⎪ of the deviation decreases as the absolute value ⎪Vr-Va⎪ of the deviation approaches zero in at least a predetermined range in which the absolute value ⎪Vr-Va⎪ of the deviation is from zero to a predetermined value. To be specific, the gain map corresponding to FIG. 7 is set such that under a condition where the absolute value ⎪Vr⎪ of the requested value is constant, the gain G decreases as the absolute value ⎪Vr-Va⎪ of the deviation decreases toward zero in at least a predetermined range in which the absolute value ⎪Vr-Va⎪ of the deviation is from zero to a predetermined value.

One example may be such that: when the absolute value ⎪Vr-Va⎪ of the deviation is in a range from zero to a predetermined value, the torque command value T increases along a quadratic curve as the absolute value ⎪Vr-Va⎪ of the deviation increases; and when the absolute value ⎪Vr-Va⎪ of the deviation exceeds the predetermined value, the torque command value T increases proportionally as the absolute value ⎪Vr-Va⎪ of the deviation increases. Even when the absolute value ⎪Vr-Va⎪ of the deviation exceeds the predetermined value, the torque command value T may increase along the quadratic curve as the absolute value ⎪Vr-Va⎪ of the deviation increases.

Therefore, as the absolute value ⎪Vr-Va⎪ of the deviation between the requested value Vr and the actual value Va of the rotational speed of the traveling motor 5 decreases, the traveling responsiveness of the lawn mower decreases. Thus, in a situation where the traveling of the lawn mower needs to be finely adjusted during the work performed by the work equipment 3, a significant change in vehicle speed is suppressed.

The technology of the present disclosure is not limited to the above-described embodiment. For example, instead of the lawn mower 1, the work machine may be a wheel loader, a snow removal vehicle, an agricultural machine, or the like. The work equipment of the wheel loader may be a bucket. The work equipment of the snow removal vehicle may be a rotary snow blower. The work equipment of the agricultural machine may be, for example, a seedling planting device, a harvesting device, or the like. The operating portion 30 may include: an accelerator that commands forward movement or backward movement; and a steering handle. The accelerator may be a lever, a pedal, or a rotatable grip. The prime mover that drives the wheels may be an internal combustion engine instead of the electric motor.

In the embodiment, the rotational speed of the traveling motor 5 is described as a parameter related to the output of the traveling motor 5. However, the parameter may be the traveling speed of the lawn mower 1. To be specific, the parameter may be a value correlated to the rotational speed of the traveling motor 5. The parameter may be acceleration of the traveling motor 5 or the lawn mower 1.

In the embodiment, the cutting blade motor 11 that drives the cutting blade driving shaft 12 is located separately from the traveling motor 5. However, a configuration in which the cutting blade driving shaft 12 is driven by the driving force extracted from the traveling motor 5 through a PTO shaft may be adopted.

Regardless of whether or not the cutting blade 13 is being driven, the first mode may be a low response mode, and the second mode may be a high response mode. To be specific, a configuration in which: in the low response mode, the gain G is determined with reference to the first gain map 43A regardless of whether the cutting blade 13 is in a driving state or a non-driving state; and in the high response mode, the gain G is determined with reference to the second gain map 43B regardless of whether the cutting blade 13 is in the driving state or the non-driving state may be adopted. For example, the low response mode may be a manned operating mode, and the high response mode may be an unmanned operating mode.

Switching between the first mode and the second mode may be performed without using the mode selector 22. For example, when a distance from the lawn mower 1 to an obstacle is less than a threshold, the first mode may be selected. Moreover, when the distance from the lawn mower 1 to the obstacle is the threshold or more, the second mode may be selected. The distance from the lawn mower 1 to the obstacle may be detected by a distance sensor included in the lawn mower 1 or may be calculated by collating an own position, detected by a positioning sensor included in the lawn mower 1, with map data.

Another example may be such that: when grass cutting resistance in an area where the lawn mower 1 travels is high, the first mode is selected; and when the grass cutting resistance in the area where the lawn mower 1 travels is low, the second mode is selected. The grass cutting resistance may be regarded as a value proportional to the amount of current supplied from the inverter 14 to the cutting blade motor 11. For example, when the amount of current supplied from the inverter 14 to the cutting blade motor 11 exceeds a threshold, it may be determined that the grass cutting resistance is high. When the amount of current supplied from the inverter 14 to the cutting blade motor 11 is less than the threshold, it may be determined that the grass cutting resistance is low.

When the grass is long or the density of the grass is high in the area where the lawn mower 1 travels, the first mode may be selected. When the grass is short or the density of the grass is low in the area where the lawn mower 1 travels, the second mode may be selected. The state of the grass on which the lawn mower 1 travels may be determined by analyzing an image taken by a camera included in the lawn mower 1.

Each of the first mode and the second mode may further include sub modes, and each gain map may be divided into sub gain maps. For example, as the sub modes, a normal mode, an eco mode, and the like may be adopted.

The operating mode may be automatically selected by the controller 8 instead of being selected by the user. As the control rule for obtaining the gain, a calculation formula may be used instead of the gain map.

The first gain map 43A may include a region where under a condition where the absolute value ⎪Vr⎪ of the requested value is constant, the gain G decreases as the absolute value ⎪Vr-Va⎪ of the deviation decreases, and may further include a region where the gain G is constant even when the absolute value ⎪Vr-Va⎪ of the deviation decreases. To be specific, the first gain map 43A may be set such that under a condition where the absolute value ⎪Vr⎪ of the requested value is constant, the gain G for a case where the absolute value ⎪Vr-Va⎪ of the deviation is a first value is smaller than the gain G for a case where the absolute value ⎪Vr-Va⎪ of the deviation is a second value larger than the first value.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The functionality of the elements disclosed herein may be implemented using circuitry or processing circuitry which includes general purpose processors, special purpose processors, integrated circuits, ASICs (Application Specific Integrated Circuits), FPGAs (Field Programmable Gate Arrays), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Aspects

The above embodiment has described specific examples of the following aspects.

### First Aspect

A work machine including:
a body;
work equipment that is mounted on the body and performs predetermined work with respect to surrounding environment of the work machine;
a wheel supporting the body;
a prime mover that drives the wheel;
a sensor that detects a user operation amount with respect to an operating portion operated by a user; and
processing circuitry configured to control the prime mover in response to a detection signal of the sensor, wherein:
the processing circuitry is configured to
   acquire an actual value of a parameter related to an output of the prime mover,
   acquire a requested value of the parameter based on the user operation amount,
   determine a gain in accordance with a predetermined control rule based on an absolute value of a deviation between the requested value and the actual value, and
   determine a torque command value with respect to the prime mover based on a value obtained by multiplying the deviation by the gain; and
   the control rule is set such that the gain for a case where the absolute value of the deviation is a first value is smaller than the gain for a case where the absolute value of the deviation is a second value larger than the first value.

According to the first aspect, the gain is small when the absolute value of the deviation between the requested value and the actual value which are related to the output of the prime mover is small. Therefore, in a situation where the traveling of the work machine needs to be finely adjusted during the work performed by the work equipment, a significant change in vehicle speed is suppressed. Thus, during the work performed by the work equipment, the user can finely adjust the traveling of the work machine with excellent feel.

### Second Aspect

The work machine according to the first aspect, wherein the processing circuitry determines the gain in accordance with the control rule based on a user command value and the absolute value of the deviation between the requested value and the actual value, the user command value being the requested value or the user operation amount.

According to the second aspect, the gain is determined based on the user command value. Therefore, the gain can be appropriately set in accordance with the magnitude of the user command value.

### Third Aspect

The work machine according to the second aspect, wherein the processing circuitry determines the gain in accordance with the control rule based on an absolute value of the user command value and the absolute value of the deviation between the requested value and the actual value.

According to the third aspect, the gain is determined with reference to the absolute value of the user command value. Therefore, it is unnecessary to use different control rules depending on whether the user command value is positive or negative. Thus, the control rule can be simplified.

### Fourth Aspect

The work machine according to any one of the first to third aspects, wherein the control rule is set such that under a condition where an absolute value of a user command value that is the requested value or the user operation amount is constant, the gain decreases as the absolute value of the deviation decreases.

According to the fourth aspect, the gain decreases as the absolute value of the deviation between the requested value and the actual value which are related to the output of the prime mover decreases. Therefore, during the work performed by the work equipment, the user can finely adjust the traveling of the work machine with excellent feel.

### Fifth Aspect

The work machine according to any one of the first to fourth aspects, wherein the control rule is set such that under a condition where the absolute value of the deviation is constant, the gain increases as an absolute value of a user command value that is the requested value or the user operation amount decreases.

According to the fifth aspect, the torque command value increases as the user operation amount decreases. Therefore, the traveling torque of the work machine that travels at low speed increases, and therefore, the traversability is improved.

### Sixth Aspect

The work machine according to any one of the first to fifth aspects, wherein:
the control rule is a first control rule;
the processing circuitry is configured to control the prime mover in accordance with a mode selected from the group consisting of a first mode and a second mode; and
when the first mode is selected, the processing circuitry determines the gain in accordance with the first control rule; and
when the second mode is selected, the processing circuitry determines the gain in accordance with a second control rule different from the first control rule.

According to the sixth aspect, the behavior of the prime mover suitable for each mode can be realized, and the operability of the work machine can be further improved.

### Seventh Aspect

The work machine according to the sixth aspect, wherein when the absolute value of the deviation is a value within a range that is larger than zero and smaller than a predetermined threshold, the gain determined in accordance with the first control rule is smaller than the gain determined in accordance with the second control rule.

According to the seventh aspect, by selecting the first mode, the user can easily and finely adjust the traveling of the work machine.

### Eighth Aspect

The work machine according to any one of the first to seventh aspects, wherein the parameter is a rotational speed of the prime mover or a value correlated to the rotational speed of the prime mover.

According to the eighth aspect, the work machine can be controlled based on speed which is a physical quantity that is easy to measure.

### Ninth Aspect

The work machine according to any one of the first to eighth aspects, wherein the prime mover includes an electric motor.

According to the ninth aspect, even in the case of the electric motor that tends to generate a sudden torque change, the user can finely adjust the traveling of the work machine with excellent feel by using the above-described control rule.

### Tenth Aspect

The work machine according to any one of the first to ninth aspects, wherein:
the work equipment includes a cutting blade driving shaft to which a cutting blade is attached; and
the work machine includes a lawn mower.

According to the tenth aspect, during the lawn mowing work performed by the cutting blade, the user can finely adjust the traveling of the lawn mower with excellent feel.

### Eleventh Aspect

A method of controlling a work machine,
the work machine including:
work equipment that performs predetermined work with respect to surrounding environment of the work machine; and
a prime mover that drives a wheel,
the method including:
acquiring an actual value of a parameter related to an output of the prime mover;
acquiring a requested value of the parameter based on a user operation amount;
determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and
determining a torque command value with respect to the prime mover based on a value obtained by multiplying the deviation by the gain.

### Twelfth Aspect

A non-transitory storage medium storing a control program for a work machine, the work machine including:
work equipment that performs predetermined work with respect to surrounding environment of the work machine; and a
prime mover that drives a wheel,
the control program causing a processor to execute:
acquiring an actual value of a parameter related to an output of the prime mover;
acquiring a requested value of the parameter based on a user operation amount;
determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and
determining a torque command value with respect to the prime mover based on a value obtained by multiplying the deviation by the gain.

What is claimed is:

1. A work machine comprising:
a body;
work equipment that is mounted on the body and performs predetermined work with respect to surrounding environment of the work machine;
a wheel supporting the body;
a prime mover that drives the wheel;
a sensor that detects a user operation amount with respect to an operating portion operated by a user; and
processing circuitry configured to control the prime mover in response to a detection signal of the sensor, wherein:
the processing circuitry is configured to
acquire an actual value of a parameter related to an output of the prime mover,
acquire a requested value of the parameter based on the user operation amount,
determine a gain in accordance with a predetermined control rule based on an absolute value of a deviation between the requested value and the actual value, and
determine a torque command value with respect to the prime mover based on a value obtained by multiplying the deviation by the gain; and
the control rule is set such that the gain for a case where the absolute value of the deviation is a first value is smaller than the gain for a case where the absolute value of the deviation is a second value larger than the first value.

2. The work machine according to claim 1, wherein the processing circuitry determines the gain in accordance with the control rule based on a user command value and the absolute value of the deviation between the requested value and the actual value, the user command value being the requested value or the user operation amount.

3. The work machine according to claim 2, wherein the processing circuitry determines the gain in accordance with the control rule based on an absolute value of the user command value and the absolute value of the deviation between the requested value and the actual value.

4. The work machine according to claim 1, wherein the control rule is set such that under a condition where an absolute value of a user command value that is the requested value or the user operation amount is constant, the gain decreases as the absolute value of the deviation decreases.

5. The work machine according to claim 1, wherein the control rule is set such that under a condition where the absolute value of the deviation is constant, the gain increases as an absolute value of a user command value that is the requested value or the user operation amount decreases.

6. The work machine according to claim 1, wherein:
the control rule is a first control rule;
the processing circuitry is configured to control the prime mover in accordance with a mode selected from the group consisting of a first mode and a second mode; and
when the first mode is selected, the processing circuitry determines the gain in accordance with the first control rule; and
when the second mode is selected, the processing circuitry determines the gain in accordance with a second control rule different from the first control rule.

7. The work machine according to claim 6, wherein when the absolute value of the deviation is a value within a range that is larger than zero and smaller than a predetermined threshold, the gain determined in accordance with the first control rule is smaller than the gain determined in accordance with the second control rule.

8. The work machine according to claim 1, wherein the parameter is a rotational speed of the prime mover or a value correlated to the rotational speed of the prime mover.

9. The work machine according to claim 1, wherein the prime mover includes an electric motor.

10. The work machine according to claim 1, wherein:
the work equipment includes a cutting blade driving shaft to which a cutting blade is attached; and
the work machine includes a lawn mower.

11. A method of controlling a work machine,
the work machine including:
work equipment that performs predetermined work with respect to surrounding environment of the work machine; and
a prime mover that drives a wheel,
the method comprising:
acquiring an actual value of a parameter related to an output of the prime mover;
acquiring a requested value of the parameter based on a user operation amount;
determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and
determining a torque command value with respect to the prime mover based on a value obtained by multiplying the deviation by the gain.

12. A non-transitory storage medium storing a control program for a work machine,
the work machine including:
work equipment that performs predetermined work with respect to surrounding environment of the work machine; and
a prime mover that drives a wheel,
the control program causing a processor to execute:
acquiring an actual value of a parameter related to an output of the prime mover;
acquiring a requested value of the parameter based on a user operation amount;
determining a gain based on an absolute value of a deviation between the requested value and the actual value in accordance with a control rule set such that the gain for a case where the absolute value of the deviation is a first value is smaller than the gain for a case where the absolute value of the deviation is a second value larger than the first value; and
determining a torque command value with respect to the prime mover based on a value obtained by multiplying the deviation by the gain.
